(19) United States
(12) Patent Application Publication
(10) Pub. No.: US 2018/0220574 A1
(43) Pub. Date: Aug. 9, 2018

(54) GAUGE WHEEL AND HITCH FORCE CONTROL

(71) Applicant: CNH Industrial Canada, Ltd., Saskatoon (CA)

(72) Inventors: Klint J. Peterson, Mackinaw, IL (US); James W. Henry, Saskatoon (CA)

(73) Assignee: CNH Industrial Canada, Ltd., Saskatoon (CA)

(21) Appl. No.: 15/428,295

(22) Filed: Feb. 9, 2017

(51) Int. Cl. A01B 63/22; A01B 79/00; A01B 73/04; A01B 49/02

(52) U.S. Cl. CPC A01B 63/22; A01B 79/00; A01B 29/04; A01B 49/027; A01B 73/04

(57) ABSTRACT

An agricultural tillage implement including a frame having a hitch extending in a travel direction, at least one gauge wheel coupled to the frame, at least one first actuator coupled to the at least one gauge wheel and configured to adjust a position of the at least one gauge wheel and thereby a control depth, a second actuator coupled to the hitch and configured to adjust a down force, and a pressure control system. The pressure control system includes a first sensor coupled to the at least one gauge wheel and a second sensor coupled to the second actuator. The pressure control system also includes a controller in communication with the first and second sensors and configured to automatically adjust the at least one first actuator and the second actuator.

### BACKGROUND OF THE INVENTION

### 1. Field of the Invention

The present invention relates to agricultural tillage tools, and, more particularly, to a pressure control system.

### 2. Description of the Related Art

Farmers utilize a wide variety of tillage implements to prepare soil for planting. Tillage implements prepare the soil by way of mechanical agitation of numerous types, such as digging, stirring, and overturning. Examples of tillage include plowing (overturning with moldboards or chiseling with chisel shanks), disking, harrowing, sweeping, and cultivating with cultivator shanks.

Tillage is often classified into two types, vertical and horizontal. Generally, vertical tillage is performed with implements such as colters or spider wheels. Horizontal tillage, on the other hand, is performed with implements such as sweeps. The employment of vertical or horizontal tillage depends upon various aspects of a given situation including soil conditions, equipment, crops to be planted, etc.

Some tillage implements may include two or more sections coupled together to perform multiple functions as they are pulled through fields by a tractor. For example, a field cultivator is capable of simultaneously tilling soil and leveling the tilled soil in preparation for planting. A field cultivator has a frame that carries a number of ground-engaging tilling implements for tilling the soil. The field cultivator converts compacted soil into a level seedbed with a consistent depth for providing excellent conditions for planting of a crop. Residual crop material, weeds, or other undesired plants disposed on top of the soil are destroyed and worked into the soil.

Additionally, some tillage implements may include an optional rear auxiliary implement to perform various secondary tasks for finishing the soil. For example, a rear auxiliary implement may include a spike tooth harrow, spring tooth harrow, rolling (aka. crumbler) basket, etc., or any combination thereof. The crumbler basket has a reel with numerous blades for breaking up dirt and sod clods into smaller sizes, chopping up the remaining debris on the top of the soil, smoothing out ridges, and slightly packing the field.

As tillage implements are moved over a field, certain field conditions as well as the tractor's velocity will cause the depth of the implement to vary. Typically, gauge wheels are employed to help regulate depth control. For example, in a ganged disk harrow, gauge wheels are used to set the penetration depth for the discs. To set a particular depth, an operator will manually adjust the height of the gauge wheels, which can be difficult and time consuming. Often, the implements weight can be unevenly distributed and will cause the gauge wheels and hitch to be under or over loaded. Under or over loading of the system may cause the implement to gouge or miss the field, exacerbate normal tool wear, or cause premature failure of the gauge wheels.

What is needed in the art is an easy to use mechanism for sensing and adjusting the down force applied to the gauge wheels and hitch of an agricultural implement.

### SUMMARY OF THE INVENTION

The present invention provides an agricultural tillage implement with a pressure control system that includes sensors and a controller to provide an equalized and consistent down force during various speeds of operation.

The invention in one form is directed to an agricultural tillage implement that includes a frame that has a hitch extending in a travel direction, at least one gauge wheel coupled to the frame, and at least one first actuator coupled to the at least one gauge wheel and configured to adjust a position of the at least one gauge wheel and thereby a control depth. The agricultural tillage implement also includes a second actuator coupled to the hitch and configured to adjust a down force, and a pressure control system operatively connected to the hitch and to the at least one gauge wheel. The pressure control system includes a first sensor coupled to the at least one gauge wheel and a second sensor coupled to the second actuator. The first and second sensors are configured respectively for sensing a first load exerted on the at least one gauge wheel and a second load exerted on the second actuator. The first and second sensors also provide a first down force measurement signal associated with the at least one gauge wheel and a second down force measurement signal associated with the second actuator. The pressure control system also includes a controller in communication with the first and second sensors and configured to automatically adjust at least one of the at least one first actuator and the second actuator.

The invention in another form is directed to a pressure control system of an agricultural instrument having a frame including a hitch extending in a travel direction, at least one gauge wheel, and a first and second actuator respectively associated with the hitch and the at least one gauge wheel. The pressure control system includes a first sensor coupled to the at least one gauge wheel and a second sensor coupled to the second actuator. The first and second sensors are configured respectively for sensing a first load exerted on the at least one gauge wheel and a second load exerted on the second actuator. The first and second sensors also provide a first down force measurement signal associated with the at least one gauge wheel and a second down force measurement signal associated with the second actuator. The pressure control system also includes a controller in communication with the first and second sensors and configured to automatically adjust at least one of the at least one first actuator and the second actuator.

The invention in yet another form is directed to a method of controlling a down pressure exerted on an agricultural implement moving in a travel direction during operation with a variance of speeds. The method includes the steps of providing a frame including a hitch extending in a travel direction, at least one gauge wheel coupled to the frame, at least one first actuator coupled to the at least one gauge wheel and configured to adjust a position of the at least one gauge wheel and thereby a control depth, a second actuator coupled to the hitch and configured to adjust a down force, and a pressure control system operatively connected to the hitch and to the at least one gauge wheel. The pressure control system includes a first sensor coupled to the at least one gauge wheel and a second sensor coupled to the second actuator. The first and second sensors are configured respectively for sensing a first load exerted on the at least one gauge wheel and a second load exerted on the second actuator, and for providing a first down force measurement signal associated with the at least one gauge wheel and a second down force measurement signal associated with the second actuator. The pressure control system also includes a controller in communication with the first and second sensors and configured to automatically adjust at least one of the at least one first actuator and the second actuator. The method includes the further steps of inputting a desired down force range into the controller, sensing the first load exerted on the at least one least one gauge wheel and the second load exerted on the second actuator, communicating the first and second down force measurement signals to the controller, comparing the first and second down force measurement signals to the desired down force range, and controlling automatically at least one of the at least one first actuator and the second actuator to maintain an evenly distributed down force in response to the variance of speeds.

An advantage of the present invention is that it prevents under or over loading of the gauge wheels.

Another advantage of the present invention is that it provides for a better seeding bed because the even distribution of down force causes there to be fewer gouges and misses in the field as well better cutting depth consistency.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

FIG. 1 is a top view of an agricultural tillage implement according to the present invention.

Corresponding reference characters indicate corresponding parts throughout the sole view. The exemplification set out herein illustrates one embodiment of the invention, in one form, and such exemplification is not to be construed as limiting the scope of the invention in any manner.

### DETAILED DESCRIPTION OF THE INVENTION

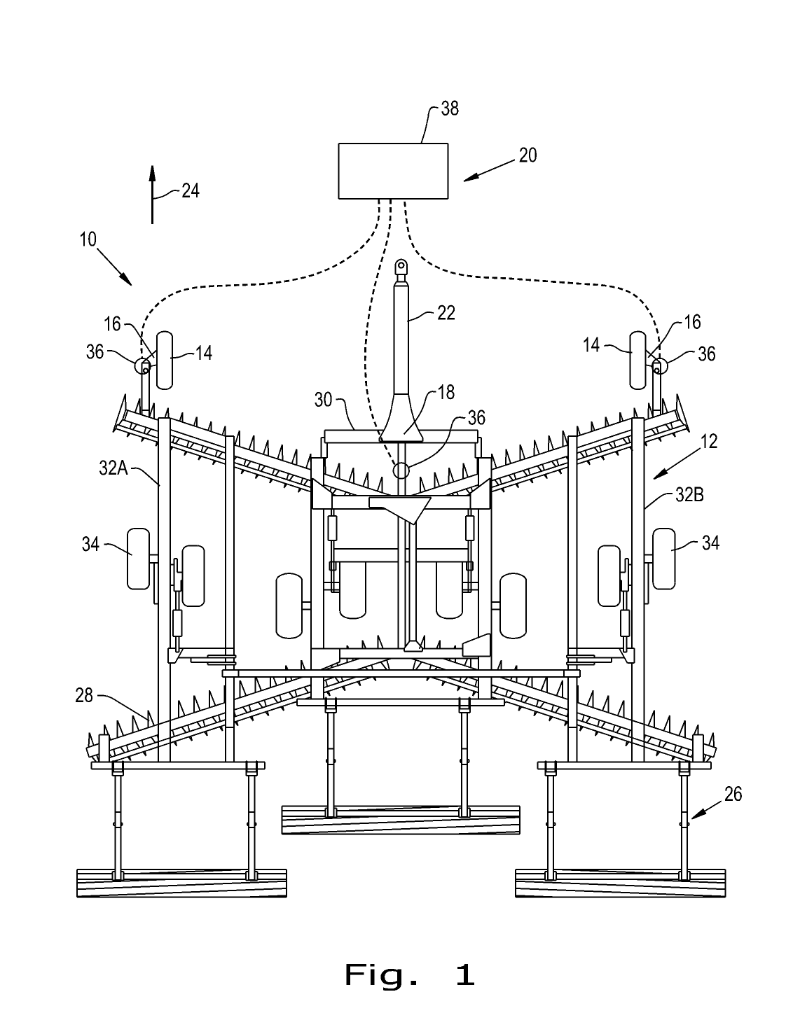

Referring now to FIG. 1, there is shown an agricultural tillage implement 10 which generally includes a frame 12, a pair of gauge wheels 14, a pair of gauge wheel actuators 16, a main hitch actuator 18, and pressure control system 20.

The agricultural tillage implement 10 is configured as a multi-section field implement, which is shown in the form of a disk harrow. The agricultural tillage implement 10 includes a hitch 22 extending in a travel direction 24. The hitch 22 is configured to connect to a towing vehicle (not shown) in a known manner. The agricultural tillage implement 10 also includes a rear auxiliary tillage implement 26 for finishing the soil. The rear auxiliary tillage implement 26 may be in the form of a rolling basket assembly, a spring tooth harrow, or a spike tooth harrow, etc. As illustrated in FIG. 1 by way of example, there is shown a ganged disk harrow 28 attached to the frame 12 of the agricultural tillage implement 10. The frame 12 may include a center main frame section 30 and a pair of folding wing sections 32A and 32B. The frame 12 is supported by a set of wheels 34, which can be hydraulically controlled.

The agricultural tillage implement 10 additionally has a hydraulic system that includes a network of hydraulic cylinders, valves, and conduits that are fluidly connected. Generally, the hydraulic system of the implement 10 is fluidly coupled with and under the control of the hydraulic system onboard the towing vehicle.

The gauge wheels 14 are coupled to each wing section 32A, 32B in order to provide support and to help regulate the control depth. The position of the gauge wheels 14 is controlled by the gauge wheel actuators 16. The gauge wheel actuators 16 may be hydraulic cylinders, which interconnect to form a hydraulic circuit that can be automatically controlled.

The main hitch actuator 18 is coupled to the hitch 22 and frame 12 in order to control the weight transfer between the hitch 22 and towing vehicle and thus the amount of down force. The main hitch actuator 18 is in the form of a hydraulic cylinder that is fluidly connected to a hydraulic circuit on board the towing vehicle.

The pressure control system 20 includes sensors 36 and a controller 38. The pressure control system 20 is operatively connected to the hitch 22 and to the pair of gauge wheels 14. The sensors 36 are located at each gauge wheel 14 and at the main hitch actuator 18. The sensors 36 measure the down force load at the gauge wheels 14 and main hitch actuator 18. As the sensors 36 collect down force data at these locations, they will provide a down force

measurement signal for each gauge wheel 14 and for the main hitch actuator 18, which will be communicated to the controller 38. The sensors 36 may be, e.g., in form of a load cell sensor or a strain gauge.

The controller 38, e.g. a CPU or processor, compensates for speed changes in the towing vehicle by controlling the gauge wheel and main hitch actuator hydraulic circuits based from down force data collected by the sensors 36. For example, if the towing vehicle increases its speed, the drag force acting on the tillage implement will change and thereby cause an uneven load between the gauge wheels 14 and hitch 22. To compensate this under or over loading, the controller 38 may adjust the hydraulic pressure in the gauge wheel actuators 16 and/or the main hitch actuator 18. The controller 38 may be located in the towing vehicle, or may be attached to the frame 12 of the agricultural tillage implement 10. The controller 38 may be programmed to receive a specific down force value that it must maintain. Additionally, the controller 38 may be programmed to receive a desired down force range such that it maintains the down force loads measured at the gauge wheels 14 and the main hitch actuator 18 within this preprogramed range.

In operation, an operator inputs a desired down force range into the controller 38. The sensors 36 sense the down force load exerted on the gauge wheels 14 and on the main hitch actuator 18. Then, the sensors communicate the down force measurement signals from both the gauge wheels 14 and main hitch actuator 18 to the controller 38. The controller 38 compares these down force measurement signals to the preprogramed down force range and subsequently controls the gauge wheel hydraulic cylinders 16 and/or the main hitch hydraulic cylinder 18 in order to maintain an even distribution of the down force across the agricultural tillage implement 10. This method is fully automatic and may be controlled using the latest tractor-implement communication system (i.e. ISOBUS Class 3 TECU).

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural tillage implement, comprising:
a frame including a hitch extending in a travel direction;
at least one gauge wheel coupled to said frame;
at least one first actuator coupled to said at least one gauge wheel and configured to adjust a position of said at least one gauge wheel and thereby a control depth;
a second actuator coupled to said hitch and configured to adjust a down force; and
a pressure control system operatively connected to said hitch and to said at least one gauge wheel, said pressure control system including:
a first sensor coupled to said at least one gauge wheel and a second sensor coupled to said second actuator, said first and second sensors are configured respectively for sensing a first load exerted on said at least one gauge wheel and a second load exerted on said second actuator, and for providing a first down force measurement signal associated with said at least one gauge wheel and a second down force measurement signal associated with said second actuator; and
a controller in communication with said first and second sensors and configured to automatically adjust at least one of said at least one first actuator and said second actuator.

2. The agricultural tillage implement of claim 1, wherein said controller receives said first and second down force measurement signals and automatically adjusts at least one of said at least one first actuator and said second actuator by determining whether said first and second down force measurement signals are within a desired down force range in response to a variance of speeds during operation.

3. The agricultural tillage implement of claim 1, wherein said frame includes a main frame and a pair of folding wing sections coupled to the main frame.

4. The agricultural tillage implement of claim 3, wherein said at least one gauge wheel is a pair of gauge wheels coupled to said pair of folding wing sections.

5. The agricultural tillage implement of claim 1, wherein said at least one first actuator is a first hydraulic cylinder and said second actuator is a second hydraulic cylinder.

6. The agricultural tillage implement of claim 5, wherein said at least one first actuator is fluidly connected to a first hydraulic circuit and said second actuator is fluidly connected to a second hydraulic circuit such that said controller individually and automatically adjusts said first and second hydraulic circuits.

7. The agricultural tillage implement of claim 1, wherein said first and second sensors are load cell sensors.

8. A pressure control system of an agricultural instrument having a frame including a hitch extending in a travel direction, at least one gauge wheel, and a first and second actuator respectively associated with said hitch and said at least one gauge wheel, said pressure control system comprising:
a first sensor coupled to said at least one gauge wheel and a second sensor coupled to said second actuator, said first and second sensors are configured respectively for sensing a first load exerted on said at least one gauge wheel and a second load exerted on said second actuator, and for providing a first down force measurement signal associated with said at least one gauge wheel and a second down force measurement signal associated with said second actuator; and
a controller in communication with said first and second sensors and configured to automatically adjust at least one of said at least one first actuator and said second actuator.

9. The pressure control system of claim 8, wherein said controller receives said first and second down force measurement signals and automatically adjusts at least one of said at least one first actuator and said second actuator by determining whether said first and second down force measurement signals are within a desired down force range in response to a variance of speeds during operation.

10. The pressure control system of claim 8, wherein said frame includes a main frame and a pair of folding wing sections coupled to the main frame.

11. The pressure control system of claim 10, wherein said at least one gauge wheel is a pair of gauge wheels coupled to said pair of folding wing sections.

12. The pressure control system of claim 8, wherein said first actuator is a first hydraulic cylinder and said second actuator is a second hydraulic cylinder.

13. The pressure control system of claim 12, wherein said first actuator is fluidly connected to a first hydraulic circuit and said second actuator is fluidly connected to a second hydraulic circuit such that said controller individually and automatically adjusts said first and second hydraulic circuits.

14. The pressure control system of claim 8, wherein said first and second sensors are load cell sensors.

15. A method of controlling a down pressure exerted on an agricultural implement moving in a travel direction during operation with a variance of speeds, the method comprising the steps of:
providing a frame including a hitch extending in a travel direction, at least one gauge wheel coupled to said frame, at least one first actuator coupled to said at least one gauge wheel and configured to adjust a position of said at least one gauge wheel and thereby a control depth, a second actuator coupled to said hitch and configured to adjust a down force, and a pressure control system operatively connected to said hitch and to said at least one gauge wheel, said pressure control system including a first sensor coupled to said at least one gauge wheel and a second sensor coupled to said second actuator, said first and second sensors are configured respectively for sensing a first load exerted on said at least one gauge wheel and a second load exerted on said second actuator, and for providing a first down force measurement signal associated with said at least one gauge wheel and a second down force measurement signal associated with said second actuator and a controller in communication with said first and second sensors and configured to automatically adjust at least one of said at least one first actuator and said second actuator;
inputting a desired down force range into said controller;
sensing said first load exerted on said at least one least one gauge wheel and said second load exerted on said second actuator;
communicating said first and second down force measurement signals to said controller;
comparing said first and second down force measurement signals to said desired down force range; and
controlling automatically at least one of said at least one first actuator and said second actuator to maintain an evenly distributed down force in response to the variance of speeds.

16. The method of claim 15, wherein said frame includes a main frame and a pair of folding wing sections coupled to the main frame.

17. The method of claim 16, wherein said at least one gauge wheel is a pair of gauge wheels coupled to said pair of folding wing sections.

18. The method of claim 15, wherein said at least one first actuator is a first hydraulic cylinder and said second actuator is a second hydraulic cylinder.

19. The method of claim 18, wherein said at least one first actuator is fluidly connected to a first hydraulic circuit and said second actuator is fluidly connected to a second hydraulic circuit such that said controller individually and automatically adjusts said first and second hydraulic circuits.

20. The method of claim 15, wherein said first and second sensors are load cell sensors.
